(19) United States
(12) Patent Application Publication
(10) Pub. No.: US 2025/0078640 A1
(43) Pub. Date: Mar. 6, 2025

(54) SAFETY SYSTEM

(71) Applicant: Sick AG, Waldkirch (DE)

(72) Inventors: Hans-Jürgen KAMMER, Waldkirch (DE); Andreas HAGEL, Waldkirch (DE)

(21) Appl. No.: 18/817,973

(22) Filed: Aug. 28, 2024

(30) Foreign Application Priority Data
Aug. 30, 2023 (DE) 10 2023 123 379.3

(51) Int. Cl. G08B 21/02

(52) U.S. Cl. CPC G08B 21/02

(57) ABSTRACT

A safety system for localizing at least one mobile object that has variable locations, having at least one control and evaluation unit, having at least one radio location system, and having at least one safety controller, wherein at least one radio transponder is arranged at the mobile object, wherein position data of the radio transponder and thus position data of the mobile object can be determined by means of the radio location system, wherein the position data can be transmitted from the radio location system to the control and evaluation unit, wherein the control and evaluation unit is configured to cyclically detect the position data of the radio transponder, wherein the control and evaluation unit is configured to evaluate the position data of the radio location system, and the radio transponder has respective safe primary signal outputs and the radio transponder has respective at least one safe secondary signal output, and wherein the safe primary signal outputs are electronically connected to the safety controller and the safe secondary signal output is connected to the safety controller.

The present invention relates to a safety system for localizing at least one mobile object that has variable locations and to a safety system for localizing at least one mobile object that has variable locations.

Vehicles are equipped with safety sensors for personal protection in the field of industrial safety engineering.

Autonomous vehicles in the industrial environment are safeguarded by Lidar safety scanners and, in a second area, by a radio safety system.

In accordance with DE 10 2019 128 782 A1, a protected field is deactivated when a safe point of interest or a safe location is recognized.

DE 10 2015 220 495 A1 discloses an adaption of a protected field of a laser scanner when traveling through a passage.

It is an object of the invention to provide an improved safety system, wherein a radio transponder should be activated as soon as it is available and should be integrated in the safety system.

The object is satisfied by a safety system for localizing at least one mobile object that has variable locations, having at least one control and evaluation unit, having at least one radio location system, and having at least one safety controller, wherein at least one radio transponder is arranged at the mobile object, wherein position data of the radio transponder and thus position data of the mobile object can be determined by means of the radio location system, wherein the position data can be transmitted from the radio location system to the control and evaluation unit, wherein the control and evaluation unit is configured to cyclically detect the position data of the radio transponder, wherein the control and evaluation unit is configured to evaluate the position data of the radio location system, wherein the radio transponder has respective safe primary signal outputs and the radio transponder has respective at least one safe secondary signal output, and herein the safe primary signal outputs are electronically connected to the safety controller and the safe secondary signal output is connected to the safety controller.

The object is further satisfied by a safety system for localizing at least one mobile object that has variable locations, having at least one control and evaluation unit, having at least one radio location system, and having at least one safety controller, wherein at least one radio transponder is arranged at the mobile object, wherein position data of the radio transponder and thus position data of the mobile object can be determined by means of the radio location system, wherein the position data can be transmitted from the radio location system to the control and evaluation unit, wherein the control and evaluation unit is configured to cyclically detect the position data of the radio transponder, wherein the control and evaluation unit is configured to evaluate the position data of the radio location system, wherein the radio transponders each have at least one safe bidirectional interface, wherein the safe bidirectional interface is electronically connected to the safety controller, and wherein respective safe primary output signals are transmitted over the safe bidirectional interface and at least safe secondary output signals are transmitted over the safe bidirectional interface.

The mobile object can be a vehicle. The vehicle can, for example, be a guideless vehicle, a driverless vehicle or an autonomous vehicle, an autonomous guided vehicle (AGV), an autonomous mobile robot (AMR) or an industrial mobile robot (IMR). The vehicle thus has a drive and can be moved in different directions.

The safety controller can also be synonymously called a safety control and evaluation unit. The safety controller is configured to evaluate signal inputs of the safety controller and to control signal outputs of the safety controller. The safety controller is, for example, a safe programmable logic controller (abbreviation: PLC).

The radio transponder has at least one primary signal output, in particular a safety related output to signal the state of the primary safety function. The primary signal output is formed, for example, by semiconductor switch outputs, e.g. an output safety switching device (OSSD).

The radio transponder furthermore has a secondary signal output, in particular a secondary safety related output that can e.g. be designed with two channels or with one channel with a periodic test. For example with a cross-circuit recognition depending on the required safety demands.

The secondary signal output or the secondary safety related signal output signals to the safety controller whether the primary signal outputs of the radio transponder should control the state of the safety controller or whether e.g. a safety sensor should control the state of the safety controller and should make a determination on the safety function.

The radio transponder outputs a safe output signal to the safety controller, and thus in particular to the mobile object, via the primary signal output or safe signal output or over the safe bidirectional interface or a safe interface. The mobile object is, for example, thereupon braked, slowed, or even stopped.

An output of safety related signals to the safety controller and thus to the mobile object, takes place via the primary safe signal outputs or the safe bidirectional interface.

The radio transponder having the primary safe signal output in particular permits the direct action on the mobile object.

The invention solves the problem of safely switching over between the radio transponder and safety sensors that may be present with a small integration effort on a transition into an environment with radio location.

If the radio transponder is registered in the radio network and can carry out its safety function, a high level should e.g. then be output at the secondary signal output.

If there is no radio connection and the primary safety function cannot be carried out, a low level should e.g. then be output at the secondary signal output.

The levels used are exemplary and can also be used conversely. In principle, a high level could thus also be output when there is no radio connection and the primary signal output or the primary safety output remains in the safe state.

The radio transponder can also be implemented with a safe bidirectional interface or a bidirectional safety bus. The described primary and secondary safety signals are then correspondingly included in the safe data.

The safe bidirectional interface is electronically connected to the safety controller, with respective safe primary output signals being transmitted over the safe bidirectional interface and respective at least safe secondary output signals being transmitted over the safe bidirectional interface.

The registration of the radio transponder takes place using automatic registration, for example. The radio transponder here permanently searches for the radio network and carries out the registration independently in the safety system.

A time routine takes place as follows, for example:

At a first point in time, the radio transponder enters a radio zone and is registered by the safety system. A localization system or a safety function is started by the control and evaluation unit.

At a second point in time, the secondary signal output of the radio transponder reports to the safety controller that the radio transponder is ready to take over the safety function. Safe signal outputs from a different safety sensor are here still in a safe state so that no hazardous state can be permitted by the safety controller.

At a third point in time, the primary signal outputs of the radio transponder are active and are evaluated by the safety controller. The safe signal outputs from a different safety sensor can be and are ignored by the safety controller.

At a fourth point in time, the radio connection to the radio transponder breaks down, for example.

At a fifth point in time, the primary signal output of the radio transponder changes to a safe state.

At a sixth point in time, the secondary signal output signals that the radio transponder no longer carries out its safety function and remains in the safe state. This means that the primary signal outputs remain in a safe state. The safety controller changes to the evaluation of the safety outputs of connected safety sensors and ignores the primary signal outputs of the radio transponder.

A simple safety system is hereby provided to change the active safety sources. It is here a simple logic with little wiring effort. Safety is ensured by a multichannel presence or by testing. I.e. proven safety principles are used.

The area of use of mobile objects or driverless transport systems such as autonomous mobile objects can be expanded to include the whereabouts of the mobile object that cannot be safeguarded by a conventional safety scanner.

The control and evaluation unit or a central RTLS server receives the measured times of flight and determines position values of the radio transponders present therefrom.

The localization of the radio transponders takes place by time of flight measurements of radio signals that are cyclically exchanged between the radio transponders and, for example, a plurality of fixed position radio stations. This evaluation works very well when the signals are transmitted at a sufficient signal strength and on a straight or direct propagation path.

The signals of a radio transponder are received by, for example, a plurality of fixed position radio stations or anchor stations and the basis for the localization is created via a time of flight measurement, e.g. the time of arrival (TOA) or e.g. the time difference of arrival (TDOA). The calculation or estimation of the position of a radio transponder then takes place on the control and evaluation unit, for example an RTLS (real time location system) server that is connected to all the radio stations or anchor stations via a wireless or wired data link. This mode of localization is called an RTLS (real time location system) mode.

The radio location system in particular has at least three arranged radio stations, with the position data being able to be transmitted from the radio station of the radio location system to the control and evaluation unit.

The radio transponder, for example, has a processing unit. The processing unit is, for example, formed by a microcontroller.

The primary signal output, in particular the safety related output to signal the state of the primary safety function can be checked in the following manner, in particular by the processing unit: For example with a cross-circuit recognition depending on the required safety demands. A checksum is provided, for example. Alternating signals can furthermore be provided. For example, a provided modulation frequency has to correspond to a specified expectation. A time-varying signal is provided, for example. A continually changeable signal is provided, for example. A time stamp is provided, for example.

The secondary signal output, in particular the secondary safety related output, that can be designed with two channels or with one channel with a periodic test can be checked in the following manner, for example, in particular by a processing unit: For example with a cross-circuit recognition depending on the required safety demands. A checksum is provided, for example. Alternating signals can furthermore be provided. For example, a provided modulation frequency has to correspond to a specified expectation. A time-varying signal is provided, for example. A continually changeable signal is provided, for example. A time stamp is provided, for example.

In a further development of the invention, the radio transponder has at least one safe signal input, with the safe signal input being connected to the safety controller. The radio transponder can be tested by the safety controller by means of the safe signal input. For example, a signal is cyclically sent from the safety controller to the radio transponder to test the radio transponder. The radio transponder can, for example, reply as feedback via the secondary signal output.

The safe signal input is checked in the following manner, for example, in particular by the processing unit: For example with a cross-circuit recognition depending on the required safety demands. A checksum is provided, for example. Alternating signals can furthermore be provided. For example, a provided modulation frequency has to correspond to a specified expectation. A time-varying signal is provided, for example. A continually changeable signal is provided, for example. A time stamp is provided, for example.

In a further development of the invention, the radio transponder has at least one trigger signal input, with the trigger signal input being connected to the safety controller.

The safety controller can start or initiate the registration of the radio transponder in the safety system by means of the trigger signal input.

In a further development of the invention, at least one spatially resolving sensor is provided for the detection of at least one object in a detection zone of the spatially resolving sensor.

The spatially resolving optoelectronic sensor is an optoelectronic sensor, for example. With a time of flight sensor as the optoelectronic sensor, for example, the light that is transmitted by a light transmitter and that is remitted by the person or object is received by a light receiver and the time of flight from the transmission up to the reception by the person or object is evaluated, whereby the distance from the person or object can be determined. This is a localization, namely for example the determination of distance and angle.

The spatially resolving sensor is, for example, an ultrasound sensor or a radar sensor.

An ultrasound sensor transmits ultrasound and evaluates the reflected sound waves, that is the echo signals. Frequencies from 16 kHz onward are used here. Detection ranges from a few centimeters up to a number of meters can be implemented here.

A radar sensor is a sensor that transmits a so-called primary signal as a bundled electromagnetic wave that receives echoes reflected from persons or objects as a secondary signal and evaluates them according to different criteria. This is a localization, namely for example the determination of distance and angle.

Position information or the position can be acquired from the received waves reflected from the person or object. As already mentioned, the angle or the direction of the object and the distance from the person or object can be determined from the time shift between the transmission and reception of the signal. The relative movement between the transmitter and the person or object can furthermore also be determined, for example by a simple multiple measurement at time intervals. The arrangement of individual measurements after one another delivers the distance and the absolute speed of the object. Contours of the person or object can be recognized with a corresponding resolution of the radar sensor.

An irradiation from the radar sensor takes place, for example, largely bundled in one direction due to the antenna design. The radiation characteristics of the antenna then has a so-called lobe shape.

The wavelength of the radar is in the range of the radio waves in the short wave to microwave range. A pulse radar sensor transmits pulses having a typical duration in the lower microsecond range and then waits for echoes. The transit time of the pulse is the time between the transmission and the reception of the echo. It is used for distance determination.

A direction of the scanning beam of a pulse radar sensor can also be effected, instead of by the alignment of the antenna or antennas, electronically by phase-controlled antenna arrays. A plurality of objects can be targeted and so-to-say simultaneously tracked in a fast alternating manner by this.

The radar sensor works at a power of approximately 10 mW, for example. This power is so low that there are no health effects. The radar frequency licensed for this application is, for example, in the range from 76-77 GHZ, corresponding to a wavelength of approximately 4 mm.

The spatially resolving sensor is, for example, configured for the at least areal monitoring of a monitored zone.

The spatially resolving sensor for the at least areal monitoring of a monitored zone is a sensor for distance measurement. The distance sensor delivers distance values in at least two-dimensional space. In so doing, the sensor outputs measured values with distance indications and angle indications. For example, the distance is determined by means of time of flight methods or triangulation methods.

The spatially resolving sensor is, for example, configured for the at least spatial monitoring of a monitored zone.

For example, the optoelectronic sensor is a laser scanner, a safety laser scanner, a 3D camera, a stereo camera, or a time of flight camera.

The spatially resolving scanner, the laser scanner, the safety laser scanner, the 3D camera, the stereo camera, or the time of flight camera monitors a two-dimensional or a three-dimensional monitored zone or a measured data contour for the position detection. It can synonymously be a monitored field.

Safety systems used in safety engineering have to intrinsically work particularly reliably and inherently safely and must therefore satisfy high safety demands, for example the standard EN13849 for safety of machinery and the machinery standard EN1496 for electrosensitive protective equipment (ESPE).

To satisfy these safety standards, a series of measures have to be taken such as a secure electronic evaluation by redundant and/or diverse electronics or different functional monitoring processes, especially the monitoring of the contamination of optical components, including a front lens. A safety laser scanner in accordance with such standards is known, for example, from DE 43 40 756 A1.

The term “functionally safe” is to be understood in the sense of the standards named or of comparable standards; measures are therefore taken to control errors up to a specified safety level. The safety system can therefore be configured as intrinsically safe. The safety system and/or at least one safe sensor moreover generate unsafe data such as raw data, point clouds, or the like. Unsafe is the opposite of safe for unsafe devices, transmission paths, evaluations, and the like and accordingly said demands on failsafeness are not satisfied.

A 3D camera, for example, likewise monitors a monitored zone by means of a plurality of detected distance values. A 3D camera has the advantage that a volume-like protected zone can be monitored.

A stereo camera, for example, likewise monitors a monitored zone by means of a plurality of detected distance values. The distance values are determined on the basis of the two camera of the stereo camera that are installed at a base spacing from one another. A stereo camera equally has the advantage that a volume-like protected zone can be monitored.

Distance values on the basis of the measured time of flight that are determined by an image sensor are determined by means of a time of flight camera. A time of flight camera equally has the advantage that a volume-like or spatial protected zone can be monitored.

A further development of the invention comprises implementing a safety system having a radio transponder, wherein the secondary signal output of the radio transponder can be used, for example, to control protected fields of the spatially resolving sensor, in particular of a laser scanner. When the safety function of the radio transponder is active, the protected fields of the laser scanner can e.g. be reduced in size.

For example, either a low level at the safe output of a safety sensor (e.g. a laser scanner) or a declining flank (or a different defined event) can trigger a registration attempt in the safety controller. This is generated, for example, in that an object that is located at a defined transition point infringes the protected field of the safety sensor.

It is important that, when the secondary signal output of the radio transponder indicates that the safety controller of the radio transponder is not active, the safety function must either evaluate the primary signal outputs of the radio transponder which are in the safe state or evaluate the safe outputs of a safety sensor, of a laser scanner for example.

The advantages is/are a saving of energy and/or potentially less radio interference.

The radio transponder can furthermore have a function that simplifies a parallel operation when equipped with a safety sensor, for example a scanner.

One function is, for example, one that permanently maintains the primary signal outputs of the radio transponder at the level HIGH when a corresponding safety related instruction is received over a radio channel of the radio transponder. In the event of an error or on a power down of the radio transponder, the primary signal outputs switch to the level LOW, that is in the safe state, independently of this function.

When the superior safety controller therefore actively uses e.g. a Lidar laser scanner or knows that this safety system is active, the safe radio transponder is bridged so that the local safety controller can thereby not change into the safe state. Safety is then ensured, for example, by the laser scanner.

In a further development of the invention, the radio location system is an ultra wideband radio location system, with the frequency used being in the range from 3.1 GHz to 10.6 GHz. The transmission energy per radio station can amount also to a maximum of 0.5 mW, for example. The transmission energy per radio station can amount also to a maximum of 1 mW amount, for example.

An absolute bandwidth in an ultrawide band radio location system amounts to at least 500 MHz or a relative bandwidth amounts to, for example, at least 20% of the central frequency.

The range of such a radio location system amounts, for example, to 0 to 50 m. In this respect, the short time duration of the radio pulses is used for the localization. The radio location system thus only transmits radio waves having a low energy.

In a further development of the invention, at least safety input signals are transmitted over the safe bidirectional interface.

In a further development of the invention, at least trigger input signals are transmitted over the safe bidirectional interface.

The invention can also be used in other radio technologies such as wireless LAN, Bluetooth, or 5G.

In a further development of the invention, a first inspection unit is provided, with the first inspection unit being connected to the control and evaluation unit, with the first inspection unit being configured to check the control and evaluation unit.

The first inspection unit or a safe RTLS watchdog controller monitors the control and evaluation unit, with the first inspection unit, for example, validating the determined position data, transmitting switchover signals for a safety status of the individual radio transponders, or initiating inspection unit reset signals to the radio transponders in dependence on the situation, for example.

The first inspection unit and the control and evaluation unit thus form at least one one-channel system with testing in accordance with ISO 13849 or, optionally, a two-channel system. The first inspection unit provides the required diagnostic measures such as are required, for example, by the relevant safety standards.

The first inspection unit or an RTLS watchdog controller serves for the monitoring and diagnosis of the safety system and of the control and evaluation unit and performs safety functions of the safety system. The first inspection unit uses the control and evaluation unit as a communication relay, for example. The first inspection unit, for example, specifically monitors the correct communication between the radio transponders, the radio stations, and the control and evaluation unit, checks the time behavior of all the components, and performs consistency checks on the data determined. The first inspection unit optionally also uses a functional block for this purpose that is performed in the control and evaluation unit or in the RTLS server.

The first inspection unit or the RTLS watchdog controller uses the checked position data of the RTLS system and, for example, information on hazard locations provided in advance by configuration, details of the operating environment, etc. to carry out an evaluation of the local hazards. This is done in the simplest case in that the distances between persons and hazard locations are determined and in that risk reducing measures are initiated on a falling below of s safety limit. A risk reduction is based, for example, on the inspection unit transmitting a safe shutdown or switchover signal to the radio transponders that they, for example, forward to a connected machine or, in the case of a radio transponder, forward a warning signal or action instructions to the person.

The invention will also be explained in the following with respect to further advantages and features with reference to the enclosed drawing and embodiments.

The Figures of the drawing show in:

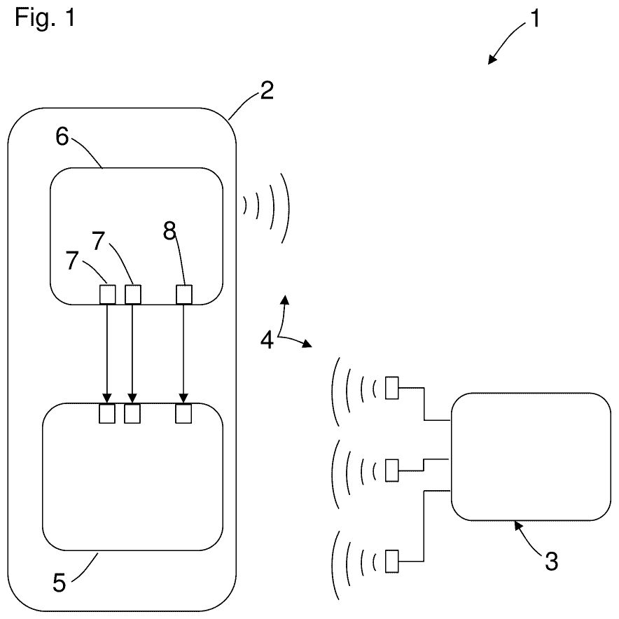

FIG. 1 to FIG. 3 respectively a safety system;

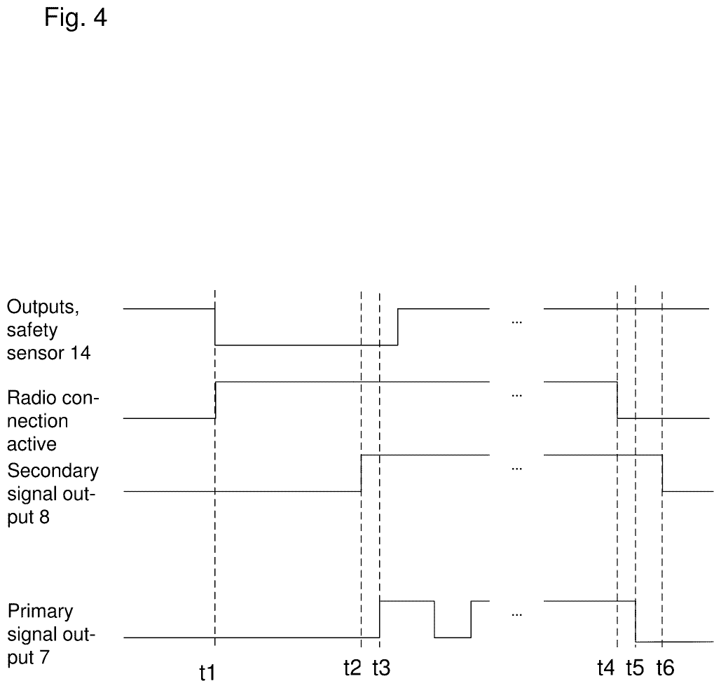

FIG. 4 a signal diagram on the time signal sequence;

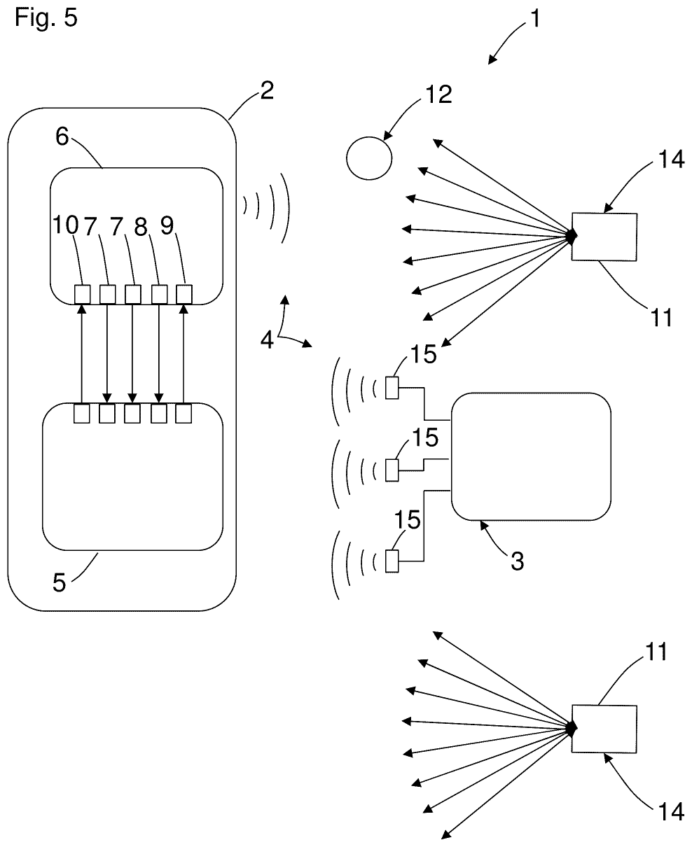

FIG. 5 a safety system; and

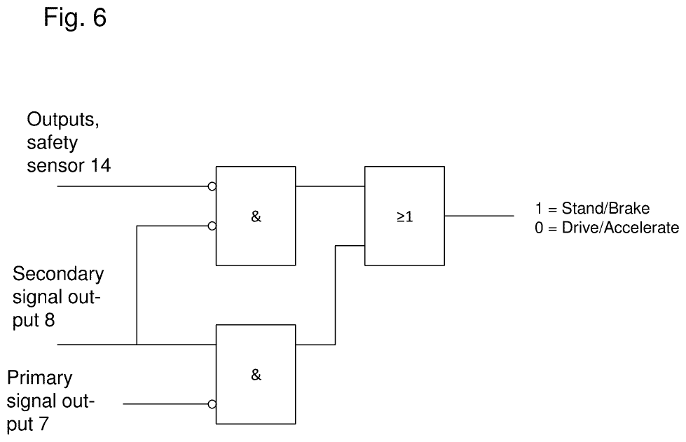

FIG. 6 a logic circuit.

In the following Figures, identical parts are provided with identical reference numerals.

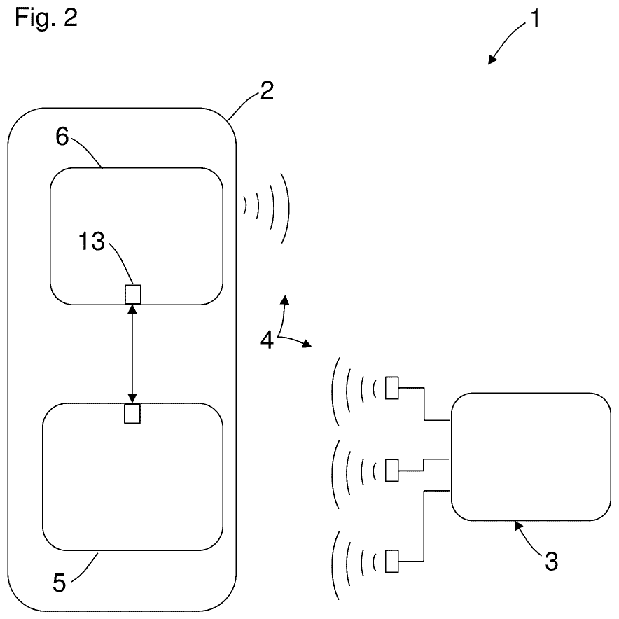

FIG. 2 shows a safety system 1 for localizing at least one mobile object 2 that has variable locations, having at least one control and evaluation unit 3, having at least one radio location system 4, and having at least one safety controller 5, wherein at least one radio transponder 6 is arranged at the mobile object 2, wherein position data of the radio transponder 6 and thus position data of the mobile object 2 can be determined by means of the radio location system 4, wherein the position data can be transmitted from the radio location system 4 to the control and evaluation unit 3, wherein the control and evaluation unit 3 is configured to cyclically detect the position data of the radio transponder 6, wherein the control and evaluation unit 3 is configured to evaluate the position data of the radio location system 4, wherein the radio transponder 6 has respective safe primary signal outputs 7 and the radio transponder 6 has respective at least one safe secondary signal output 8, and wherein the safe primary signal outputs 7 are electronically connected to the safety controller 5 and the safe secondary signal output 8 is connected to the safety controller 5.

FIG. 2 shows a safety system for localizing at least one mobile object 2 that has variable locations, having at least one control and evaluation unit 3, having at least one control and evaluation unit 4, and having at least one safety controller 5, wherein at least one radio transponder 6 is arranged at the mobile object 2, wherein position data of the radio transponder 6 and thus position data of the mobile object 2 can be determined by means of the radio location system 4, wherein the position data can be transmitted from the radio location system 4 to the control and evaluation unit 3, wherein the control and evaluation unit 3 is configured to cyclically detect the position data of the radio transponder 6, wherein the control and evaluation unit 3 is configured to evaluate the position data of the radio location system 4, wherein the radio transponder has a respective at least one safe bidirectional interface 13, wherein the safe bidirectional interface 13 is electronically connected to the safety controller 5, and wherein respective primary output signals are transmitted over the safe bidirectional interface 13, and respective at least safe secondary output signals are transmitted over the safe bidirectional interface 13.

The mobile object 2 can be a vehicle, for example.

At least safe input signals are, for example, transmitted over the safe bidirectional interface 13 in accordance with FIG. 2. For example, at least trigger signal input signals are transmitted over the safe bidirectional interface 13.

The safety controller 5 is configured to evaluate signal inputs of the safety controller 5 and to control signal outputs of the safety controller 5.

The radio transponder 6 in accordance with FIG. 1 has at least one primary signal output 7, in particular a safety related output to signal the state of the primary safety function. The primary signal output 7 is formed, for example, by semiconductor switch outputs, e.g. an output safety switching device (OSSD).

The radio transponder 6 furthermore has a secondary signal output 8, in particular a secondary safety related output that can e.g. be designed with two channels or with one channel with a periodic test. For example with a cross-circuit recognition depending on the required safety demands.

The secondary signal output 8 or the secondary safety related signal output signals to the safety controller 5 whether the primary signal outputs 7 of the radio transponder 6 should control the state of the safety controller 5 or whether e.g. a safety sensor 14 should control the state of the safety controller 5 and should make a determination on the safety function.

The radio transponder 6 outputs a safe output signal to the safety controller 5, and thus in particular to the mobile object 2, via the primary signal output 7 or safe signal output or over the safe bidirectional interface 13 in accordance with FIG. 2 or a safe interface 13. The mobile object 2 is, for example, thereupon braked, slowed, or even stopped.

An output of safety related signals to the safety controller 5 and thus to the mobile object 2 takes place via the primary safe signal outputs 7 or the safe bidirectional interface 13.

The radio transponder 6 having the primary safe signal output 7 in particular permits the direct action on the mobile object 2.

If the radio transponder 6 is registered in the radio network and can carry out its safety function, a high level should e.g. then be output at the secondary signal output 8.

If there is no radio connection and the primary safety function of the radio transponder 6 cannot be carried out, a low level should e.g. then be output at the secondary signal output 8.

The levels used are by way of example and can also be used conversely.

The radio transponder 6 can also be implemented in accordance with FIG. 2 with a safe bidirectional interface 13 or a bidirectional safety bus. The described primary and secondary safety signals are then correspondingly included in the safe data that are transmitted over the bidirectional interface 13.

The safe bidirectional interface 13 is electronically connected to the safety controller 5, with respective safe primary output signals being transmitted over the safe bidirectional interface 13 and respective at least safe secondary output signals being transmitted over the safe bidirectional interface 13.

The registration of the radio transponder 6 takes place in the safety system 1 place using automatic registration, for example. The radio transponder 6 here permanently searches for the radio network and carries out the registration 1 independently in the safety system 1.

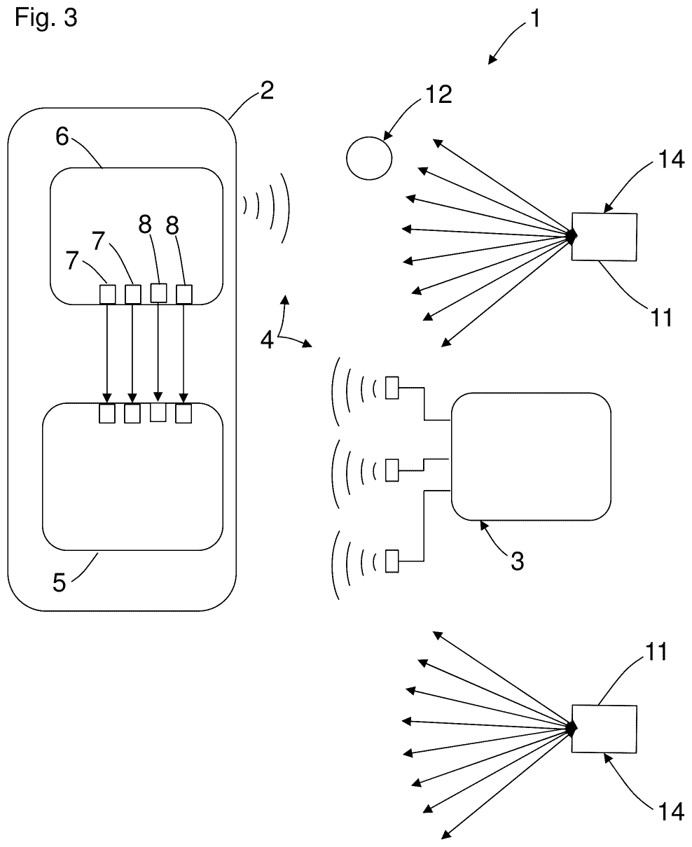

In accordance with FIG. 3, at least one safety sensor 14 is provided as the spatially resolving sensor 11 for the detection of at least one object 12 in a detection zone of the spatially resolving sensor 11 is provided

The spatially resolving optoelectronic sensor 11 is an optoelectronic sensor, for example. With a time of flight sensor as the optoelectronic sensor, for example, the light that is transmitted by a light transmitter and that is remitted by a person or object 12 is received by a light receiver and the time of flight from the transmission up to the reception by the person or object is evaluated, whereby the distance from the person or object can be determined. This is a localization, namely for example the determination of distance and angle.

The spatially resolving sensor 11 is, for example, configured for the at least areal monitoring of a monitored zone.

The spatially resolving sensor 11 is, for example, configured for the at least spatial monitoring of a monitored zone.

For example, the optoelectronic sensor is a laser scanner, a safety laser scanner, a 3D camera, a stereo camera, or a time of flight camera.

The spatially resolving scanner 11, the laser scanner, the safety laser scanner, the 3D camera, the stereo camera, or the time of flight camera monitors a two-dimensional or a three-dimensional monitored zone or a measured data contour. It can synonymously be a monitored field.

A time routine takes place as follows in accordance with FIG. 4, for example:

At a first point in time t1, the radio transponder 6 enters a radio zone and is registered by the safety system 1. A localization function or a safety function is started by the control and evaluation unit 3.

At a second point in time t2, the secondary signal output of the radio transponder 6 reports to the safety controller 5 that the radio transponder is ready to take over the safety function. Safe signal outputs from a different safety sensor 14 are here still in a safe state so that no hazardous state can be permitted by the safety controller 5.

At a third point in time t3, the primary signal outputs 7 of the radio transponder 6 are active and are output by the safety controller 5. The safe signal outputs from a different safety sensor 14 can be and are ignored by the safety controller 5.

At a fourth point in time t4, the radio connection to the radio transponder 6 breaks down, for example.

At a fifth point in time t5, the primary signal output 7 of the radio transponder 6 changes to a safe state.

At a sixth point in time t6, the secondary signal output 8 signals that the radio transponder 6 no longer carries out its safety function and remains in the safe state. This means that the primary signal outputs 7 remain in a safe state. The safety controller 5 changes to the evaluation of the safety outputs of connected safety sensors 14 and ignores the primary signal outputs 7 of the radio transponder 6.

A simple safety system 1 is hereby provided to change the active safety sources.

The area of use of mobile objects 2 or driverless transport systems such as autonomous mobile objects can be expanded to include the whereabouts of the mobile object that cannot be safeguarded by a conventional safety scanner.

The control and evaluation unit 3 or a central RTLS receives the measured signal times of flight and determines position values of the radio transponders 6 present therefrom.

The localization of the radio transponders 6 takes place by time of flight measurements of radio signals that are cyclically exchanged between the radio transponders 6 and a for example plurality of fixed position radio stations 15.

The radio location system 4 in particular has, in accordance with FIG. 5, at least three arranged radio stations 15, with the positions being able to be transmitted from the radio station 15 of the radio location system 4 to the control and evaluation unit 3.

In accordance with FIG. 5, the radio transponder 6 has at least one safe signal input 9, with the safe signal input 9 being connected to the safety controller 5. The radio transponder 6 can be tested by the safety controller 5 by means of the safe signal input 9. For example, a signal is cyclically sent from the safety controller 5 to the radio transponder 6 to test the radio transponder 6. The radio transponder 6 can, for example, reply as feedback via the secondary signal output.

In accordance with FIG. 5, the radio transponder 6 has at least one trigger signal input 10, with the trigger signal input 10 being connected to the safety controller 5.

The safety controller 6 can start or initiate the registration of the radio transponder 6 in the safety system 1 by means of the trigger signal input 10.

A further development comprises implementing a safety system 1 having a radio transponder 6, wherein the secondary signal output 8 of the radio transponder 6 can be used, for example, to control protected fields of the safety sensor 14, 'in particular of the spatially resolving sensor, in particular of a laser scanner. When the safety function of the radio transponder 6 is active, the protected fields of the laser scanner can e.g. be reduced in size.

For example, either a low level at the safe output of a safety sensor 14 (e.g. a laser scanner) or a declining flank (or a different defined event) can trigger a registration attempt in the safety controller 5. This is generated, for example, in that an object that is located at a defined transition point infringes the protected field of the safety sensor 14.

It is important that, when the secondary signal output 8 of the radio transponder 6 indicates that the safety controller 5 of the radio transponder 6 is not active, the safety function must either evaluate the primary signal outputs 7 of the radio transponder 6 which are in the safe state or evaluate the safe outputs of a safety sensor 14, of a laser scanner, for example.

The radio transponder 6 can furthermore have a function that simplifies a parallel operation when equipped with a safety sensor 14, for example a scanner.

One function is, for example, one that permanently maintains the primary signal outputs 7 of the radio transponder 6 at the level HIGH when a corresponding safety related instruction is received over a radio channel of the radio transponder 6. In the event of an error or on a power down of the radio transponder 6, the primary signal outputs 7 switch to the level LOW, that is, in the safe state, independently of this function.

When the superior safety controller 5 therefore actively uses e.g. a Lidar laser scanner or knows that this safety system 1 is active, the safe radio transponder 6 is bridged so that the local safety controller 5 can thereby not change into the safe state. Safety is then ensured, for example, by the safety sensor 14 or the laser scanner.

For example, the radio location system 4 is an ultra wideband radio location system, with the frequency used being in the range from 3.1 GHz to 10.6 GHz.

FIG. 6 shows a simple implementation example. A simple logic that is implemented in the safety controller of a mobile object can evaluate the safety outputs of the safety sensor and the primary signal outputs 7 and the secondary signal outputs 8 as follows:

| | | | Brake |
|---|---|---|---|
| Primary signal | Signal output, | Secondary | mobile |
| output 7 | safety sensor 14 | signal output 8 | object |
| Don't care | 0 | 0 | 1 |
| Don't care | 1 | 0 | 0 |
| 0 | Don't care | 1 | 1 |
| 1 | Don't care | 1 | 0 |

For reasons of clarity, the state of the safe two-channel signals is shown as a one-channel state.

### REFERENCE NUMERALS

1 safety system
2 mobile object
3 control and evaluation unit
4 radio location system
5 safety controller
6 radio transponder
7 primary signal outputs
8 secondary signal outputs
9 safe signal input
10 trigger signal input
11 spatially resolving sensor
12 object
13 safe bidirectional interface
14 safety sensor
15 radio stations

1. A safety system for localizing at least one mobile object that has a variable location, having at least one control and evaluation unit, having at least one radio location system, and having at least one safety controller,
wherein at least one radio transponder is arranged at the mobile object;
wherein position data of the radio transponder and thus position data of the mobile object can be determined by means of the radio location system;
wherein the position data can be transmitted from the radio location system to the control and evaluation unit,
wherein the control and evaluation unit is configured to cyclically detect the position data of the radio transponder;
wherein the control and evaluation unit is configured to evaluate the position data of the radio location system, and
wherein the radio transponder has respective safe primary signal outputs;
and the radio transponder has respective at least one safe secondary signal output,
with the safe primary signal output being electronically connected to the safety controller; and
the safe secondary signal being connected to the safety controller.

2. The safety system in accordance with claim 1, whereins the radio transponder has at least one safe signal input, with the safe signal input being connected to the safety controller.

3. The safety system in accordance with claim 1, wherein the radio transponder has at least one trigger signal input, with the trigger signal input being connected to the safety controller.

4. The safety system in accordance with claim 1, wherein at least one spatially resolving sensor is provided in a detection zone of the spatially resolving sensor for the detection of at least one object.

5. The safety system in accordance with claim 1, wherein the radio location system is an ultra wideband radio location system, with the frequency used being in the range from 3.1 GHz to 10.6 GHZ.

6. The safety system in accordance with claim 1, wherein a first inspection unit is provided, with the first inspection unit being connected to the control and evaluation unit, and with the inspection unit being configured to check the control and evaluation unit.

7. A safety system for localizing at least one mobile object that has a variable location, having at least one control and evaluation unit, having at least one radio location system, and having at least one safety controller,
wherein at least one radio transponder is arranged at the mobile object;
wherein position data of the radio transponder and thus position data of the mobile object can be determined by means of the radio location system;
wherein the position data can be transmitted from the radio location system to the control and evaluation unit,
wherein the control and evaluation unit is configured to cyclically detect the position data of the radio transponder,
wherein the control and evaluation unit is configured to evaluate the position data of the radio location system,
wherein the radio transponder has respective at least one safe bidirectional interface;
with the safe bidirectional interface being electronically connected to the safety controller;
with respective safe primary output signals being transmitted over the safe bidirectional interface;
and with respective at least safe secondary output signals being transmitted over the safe bidirectional interface.

8. The safety system in accordance with claim 6, wherein at least safe input signals are transmitted over the safe bidirectional interface.

9. The safety system in accordance with claim 6, wherein at least trigger signal input signals are transmitted over the safe bidirectional interface.
